(19) United States
(12) Patent Application Publication
(10) Pub. No.: US 2008/0251702 A1
(43) Pub. Date: Oct. 16, 2008

(54) Light barrier device and method of manufacturing a light barrier device

(75) Inventors: Edgar Melzner, Muenchen (DE); Kerstin Rintelmann, Brannenburg (DE); Georg Legen, Weilheim (DE)

Correspondence Address: Lipsitz & McAllister, LLC, 755 MAIN STREET, MONROE, CT, 06468, US

(73) Assignee: BALLUFF GmbH, Neuhausen (DE)

(21) Appl. No.: 11/825,126

(22) Filed: Jul. 3, 2007

(30) Foreign Application Priority Data
Apr. 16, 2007 (DE) 20 2007 005 710.5

(51) Int. Cl. G02B 7/00

(52) U.S. Cl. 250/234

(57) ABSTRACT

Light barrier device, comprising a housing, a light source, by means of which a radiation beam may be emitted, and a light receiver, wherein the light source and/or the light receiver is positioned on the housing with a joint device, by means of which the light source and/or the light receiver is movable relative to the housing for alignment of the optical axis.

The present disclosure relates to the subject matter disclosed in German utility model application number 20 2007 005 710.5 of Apr. 16, 2007, which is incorporated herein by reference in its entirety and for all purposes.

### BACKGROUND OF THE INVENTION

The invention relates to a light barrier device, comprising a housing, a light source, by means of which a radiation beam may be emitted, and a light receiver.

The radiation beam has an intensity distribution with a center, in which the maximum intensity prevails. This center defines the optical axis.

Optical faults of the light source in a light barrier device may lead to the radiation beam not being incident centrally on the light receiver. Particularly if the light source comprises a laser diode, the deviations that then arise may have a negative influence on the properties of the light barrier device.

### SUMMARY OF THE INVENTION

In accordance with the present invention, a light barrier device that is easy to manufacture and/or use is provided.

In accordance with an embodiment of the invention, the light source and/or the light receiver is positioned on the housing with a joint device, by means of which the light source and/or the light receiver is movable relative to the housing for alignment of the optical axis.

By virtue of the joint device optical faults of the light source (and also of the light receiver), which even with otherwise exact installation may lead to a non-central alignment, may be compensated. For example, during manufacture the light source (and/or the light receiver) may be aligned by means of the joint device in order to achieve a central incidence of the radiation beam, i.e. allow an exact alignment of the optical axis relative to light source and light receiver.

In accordance with the present invention, a light barrier device is provided that combines a simple construction with the ability to prevent non-central deviations.

For example, the light barrier device in accordance with the invention takes the form of a forked light barrier or an angular light barrier.

The light barrier and/or the light receiver may advantageously be aligned during manufacture of the light barrier device and/or during operation of the light barrier device. An ability to carry out alignment during manufacture allows optical faults and the like to be compensated. For example, for this purpose, on completion of alignment an obtained position is fixed. An ability to carry out alignment during operation (i.e. subsequent to manufacture) is also possible.

The joint device may be designed in various ways. For example, the joint device may comprise a plastically deformable joint element, which holds the light source and/or the light receiver. By permanent deformation of such a joint element a specific position of the light source and/or of the light receiver may be set.

In an advantageous embodiment, the joint device comprises rigid joint elements, which are movable relative to one another. Such a joint device is easy to manufacture. It is moreover easy to carry out the alignment as well as the fixing of an established alignment.

In particular, the joint device has a first pivotal axis, which is oriented transversely of a principal direction of the radiation beam. This first pivotal axis is preferably oriented at least approximately at right angles to a principal direction of the radiation beam. (Because of optical faults the first pivotal axis need not be oriented precisely at right angles to the radiation beam.) The first pivotal axis in this case need not be a spatially fixed pivotal axis. It may also vary spatially.

For the same reason, it is advantageous if the joint device has a second pivotal axis, which is oriented transversely of the first pivotal axis and is oriented transversely of the principal direction of the radiation beam. By means of the first pivotal axis and the second pivotal axis the radiation beam may be aligned in a solid angular range. During manufacture of the light barrier device it is therefore possible to achieve an exact central alignment of the radiation beam relative to the light receiver, even if there are optical faults at the light source.

It is quite particularly advantageous if the joint device takes the form of a ball joint. Such a joint device is easy and economical to manufacture. It may be of a space-saving design.

It is quite particularly advantageous if the joint device comprises a holding body, on which the light source is fixed. The holding body may at least during manufacture be mounted pivotably on the housing. Through alignment of the holding body, the radiation beam may be aligned centrally relative to the light receiver. The light source and/or the light receiver may easily be fixed in turn on the holding body. The holding body may also accommodate an optical device of the light source and/or of a light receiver. For example, lenses and apertures may be disposed on the holding body.

It is advantageous if the holding body at least in a bearing region has a spherical surface. This makes it easy to provide an ability to pivot about two (or even more) axes to allow an alignment of the radiation beam.

The light barrier device is easy to manufacture if the light source and/or the light receiver is seated in a recess of the holding body. The holding body may easily be manufactured for example as an injection-moulded part. The light source and/or the light receiver may then be fixed in the recess.

It is advantageous if a holding body for the light source and/or a holding body for the light receiver is seated on a holding element, which is disposed on the housing. The holding element with the holding body and with the light source and/or the light receiver may therefore be inserted as a whole into the housing. Assembly may therefore be simplified.

In one embodiment, the holding element comprises at least a first holding arm and a second holding arm, between which the holding body is seated. The holding body is therefore clamped between the first holding arm and the second holding arm. The holding body with the light source and/or the light receiver is therefore easy to fix on the holding element, wherein a pivot bearing arrangement is easily possible.

It is advantageous if the first holding arm and/or the second holding arm are of a resilient design. This makes it easy to fix the holding body. The holding body may be inserted between the first holding arm and the second holding arm and is then held by a pinching action on the holding element. Holding by a pinching action is a non-positive fixing that allows the holding body to be rotatable on the holding element. An alignment of the radiation beam of the light source and/or of a receiving area of the light receiver is therefore possible.

In this connection it is advantageous if the first holding arm and/or the second holding arm have at least one recess, into which the holding body at least partially enters. This at least one recess allows the holding body to be easily pivotable.

It may be provided that the holding element takes the form of a housing push-in element that is fixed to the housing. This allows prefabrication of a light source unit and/or light receiver unit. This light source unit and/or light receiver unit plus the holding element, the holding body and the light source and/or the light receiver may be positioned as a whole on the housing. Manufacture is therefore simplified.

It may be provided that a holding body of the joint device comprises one or more areas for application of a positioning element. Such areas for attachment are designed for example as channel-type recesses. A positioning rod is insertable as a positioning element into such a recess. By a corresponding exertion of force on the positioning element, a pivoted position of the holding body may be set for example manually during manufacture of the light barrier device.

It is also possible for at least one positioning element to be permanently disposed on a holding body. An alignment operation is therefore easily possible. The at least one positioning element is an integral component of the articulated device. For example, spaced positioning rods are disposed, which are connected by a bridge provided with a gripping surface. An operator may align the light source and/or the light receiver by exerting force on this bridge.

It is in particular provided that the light source and/or the light receiver is fixed in a specific pivoted position relative to the housing. The fixing is effected after alignment of the light source and/or the light receiver. On completion of alignment, the principal direction of the radiation beam (i.e. the optical axis) is therefore fixed. Even an inadvertent displacement is then no longer possible.

It is in principle possible for the joint device to comprise a plastically deformable holding body, by virtue of the plastic deformation of which the light source and/or the light receiver may be aligned. For this purpose, the holding body is manufactured for example as an injection-moulded part from a suitable plastically deformable material. The light source and/or the light receiver is fixed on the holding body. By virtue of a corresponding action of force upon the holding body and the plastic deformation thereof, the alignment is effected. An obtained alignment may be secured for example by means of wedge elements or the like.

It may be provided that the housing at least in the region of the light source and/or of the light receiver is filled with an, in particular hardened, filling material. For example, a filling is effected with an epoxy resin. By means of the filling operation it is possible to fix the position of the joint device and hence the alignment of the radiation beam.

The light source comprises for example a light-emitting diode and/or is formed by a light-emitting diode.

It is also possible for the light source to comprise a laser diode. In this case, the light source may comprise further elements and in particular an optical imaging device.

It may be provided that the light barrier device comprises a first arm, on which the light source is disposed, and a second arm, on which the light receiver is disposed. Between the first arm and the second arm there is then situated during operation of the light barrier device a radiation beam, wherein the penetrating of the radiation beam by an object is detectable.

It may be provided that pivotal axes of the joint device are substantially parallel to a housing side of the first arm that faces the second arm. Thus, an alignment of the radiation beam at least during manufacture of the light barrier device is easily possible.

In this case, it may be provided that the first arm and the second arm are substantially parallel to one another.

In an embodiment, the first arm and the second arm are connected by a bridge. A forked light barrier is therefore formed. In particular, the bridge is situated on or in the vicinity of an end of the respective first arm and of the second arm that is remote from an end, on or in the vicinity of which the light source and/or the light receiver is situated.

For example, the bridge is oriented substantially at right angles to the first arm and the second arm.

In this case, it may be provided that an electrical circuit arrangement is positioned on the bridge. Room may be provided on the bridge for accommodating the electrical circuit arrangement.

It is then advantageous if a plug connection element is disposed on the bridge. This may be positioned directly behind the electrical circuit arrangement, so that the corresponding line paths may be kept short.

It is also possible for the first arm and the second arm to be directly connected to one another. In this case, the light barrier device takes the form of an angular light barrier. An optical axis is then oriented at an angle to the corresponding arms.

During manufacture of the light barrier device, for example a light receiver is positioned on a housing, a light source is positioned by means of a joint device on the housing, and the light source is aligned relative to the light receiver by means of the joint device.

In this way, optical faults of the light source may be compensated during manufacture of the light barrier device. In particular, even given the presence of optical faults, a central alignment of a radiation beam of the light source relative to the light receiver is achievable.

In particular, the light source may be aligned at least by means of a first pivotal axis and a second pivotal axis. Thus, a central alignment both to the left and right as well as in an upward and downward direction relative to the light receiver may be achieved.

It is then advantageous if the first pivotal axis and the second pivotal axis each lie transversely of a principal direction of a radiation beam of the light source.

It is quite particularly advantageous if the light source after alignment is fixed so as to be locked against pivoting relative to the housing. Once an alignment has been achieved, then this aligned position may be secured by means of the fixing operation. A, for example inadvertent, pivoting out of a position once aligned is then no longer possible.

It may in this case be provided that the light source is fixed in the housing by means of a filling material. For example, the housing at least in the region of the light source is filled. As a result of the hardening of the appropriate filling material (such as for example an epoxy resin), the position of the light source relative to the light receiver is then fixed.

It is advantageous if the joint device comprises a holding body that is disposed on a holding element. The combination of holding element and holding body may therefore be positioned on the housing.

In particular, the holding element takes the form of a housing push-in element, which is fixed on the housing. This allows a combination of light source, holding body and holding element to be manufactured separately from the housing and positioned on the housing.

It is also possible for the light receiver to be positioned by means of a joint device on the housing. In this way, the light receiver too may be aligned.

The following description of preferred embodiments serves in connection with the drawings to provide a detailed explanation of the invention.

### BRIEF DESCRIPTION OF THE DRAWINGS

FIG. 1 shows a diagrammatic representation of an embodiment of a light barrier device according to the invention;

FIG. 2 shows a perspective part-sectional representation of the region A according to FIG. 1 in a first embodiment;

FIG. 3 shows a plan view in the direction B according to FIG. 2;

FIG. 4 shows a side view of the sub-region according to FIG. 2;

FIG. 5 shows a perspective part-sectional representation of the region A in a second embodiment;

FIG. 6 shows a plan view in the direction C according to FIG. 5;

FIG. 7 shows a side view of the region according to FIG. 5; and

FIG. 8 shows a diagrammatic representation of a further embodiment of a light barrier device according to the invention.

### DETAILED DESCRIPTION OF THE INVENTION

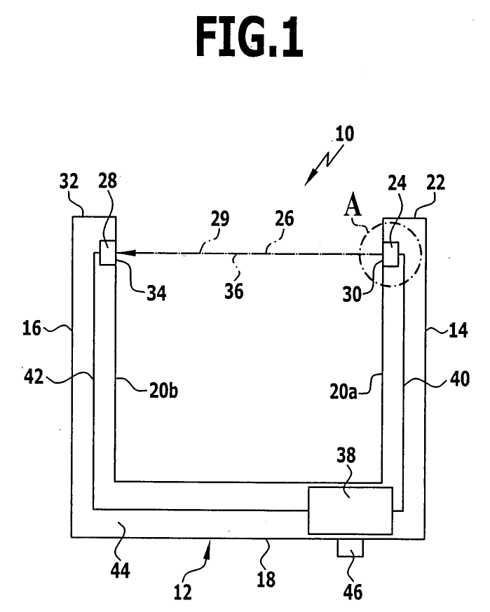

An embodiment of a light barrier device according to the invention, which is shown in FIG. 1 and denoted there by 10, takes the form of a forked light barrier. The light barrier device 10 comprises a housing 12 having a first arm 14, an opposite second arm 16, and a bridge 18 that connects the first arm 14 and the second arm 16. The first arm 14 and the second arm 16 are disposed substantially parallel to one another. The first arm 14 has a housing side 20a that faces a corresponding housing side 20b of the second arm 16.

The bridge 18 is situated transversely of, and in particular at right angles to, the first arm 14 and the second arm 16.

Disposed on the first arm 14 in the region of an end 22 remote from the bridge 18 is a light source 24. This light source 24 may be for example a light-emitting diode or a laser diode with a corresponding optical system. The light source 24 emits a radiation beam 26 in the direction of a light receiver 28. Disposed on the housing 12 on the first arm 14 is a window 30, through which light of the light source 24 may pass. An optical axis 29 is defined by the region of maximum intensity of the radiation beam 26, which has a, for example gaussian, intensity distribution.

The light receiver 28 is disposed on the second arm 16 in the vicinity of an end 32. It is aligned with the light source 24, so that the radiation beam 26 is detectable.

In a corresponding manner there is disposed on the second arm 16 a window 34, through which light of the radiation beam 26 may pass into the housing 12 and is then detectable by the light receiver 28.

The light source 24 and the light receiver 28 lie substantially on the same optical axis. A principal direction 36 of the radiation beam 26 lies at least approximately at right angles to the first arm 14 and the second arm 16. The radiation beam 26 forms a light barrier, the penetration of which by an object is detectable; the penetration leads to a shading of the light receiver 28.

Disposed in the region of the web 18 on the housing 12 is an electrical circuit arrangement 38, which in particular comprises an evaluation device for the light barrier device 10. The light source 24 is connected by one or more lines 40 to the electrical circuit arrangement 38. In a corresponding manner, the light receiver 28 is connected by one or more lines 42 to the electrical circuit arrangement 38. Through the line and/or lines 40 control signals may be transmitted to the light source 24 and the light source 24 may be supplied with electrical energy. Through the line 42 sensor signals may be transmitted to the electrical circuit arrangement 38 and the light receiver 28 may be supplied with electrical energy.

The housing 12 has an inner chamber 44, in which the light receiver 28, the light source 24 and the electrical circuit arrangement 38 are disposed. This inner chamber 44 may be coherent or comprise separate sub-chambers. The housing 12 is closed for example by a housing lid. The inner chamber 44 may be filled at least partially with a filling material and be in particular potted. For example a filling with an epoxy resin is provided. Instead of a housing lid, an inner chamber of the housing may be closed exclusively by filling.

Disposed on the bridge 18 in the vicinity of the electrical circuit arrangement 38 is a plug connection element 46, via which detection signals of the light barrier device 10 may be picked off and via which the light barrier device 10 may be supplied with electrical energy.

It is in principle desirable for the radiation beam 26 to be incident with its principal direction 36 centrally on the light receiver 28, i.e. for the optical axis 29 to meet the light receiver 28 centrally. Optical faults of the light source 24 (“skew errors”) may lead to off-center incidence.

According to the invention, the light source 24 is positioned by means of a joint device on the housing 12, so that during manufacture a correction of the alignment between the light source 24 and the light receiver 28 is possible in order to compensate optical faults.

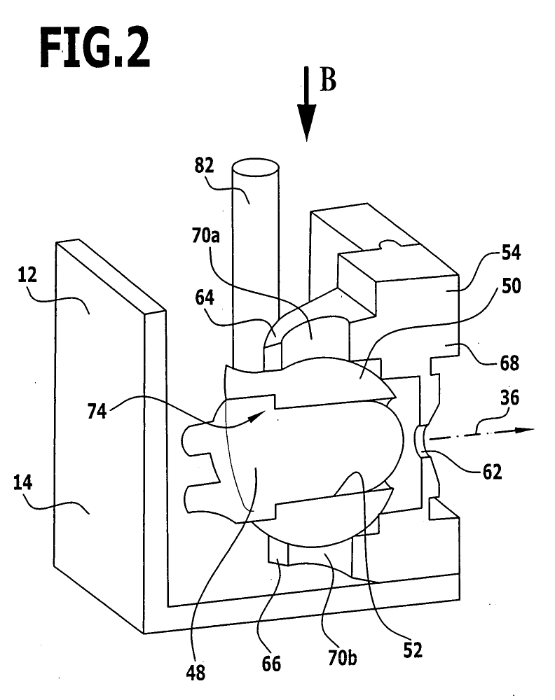

In a first embodiment, which is shown in FIGS. 2 to 4, a light-emitting diode 48 is provided as a light source. The light-emitting diode 48 is positioned on a holding body 50. The holding body 50 for example has a recess 52, in which the light-emitting diode 48 is inserted.

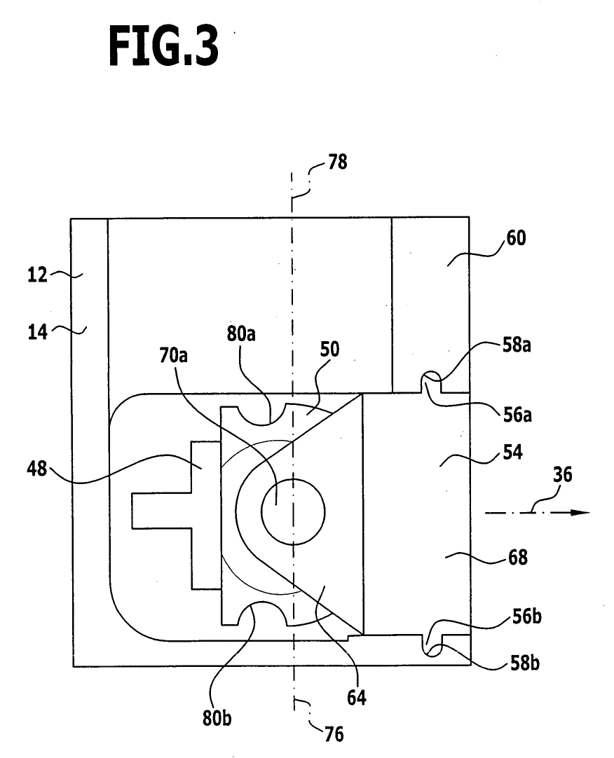

The holding body 50 is held on a holding element 54. The holding element 54 takes the form of a housing push-in element, which is held on the housing 12. The holding element 54 has for example holding strips 56a, 56b (FIG. 3), which are pushed into corresponding recesses 58a, 58b of a housing wall 60. The housing wall 60 in this case forms the housing side 20a of the first arm 14. On the holding element 54 the window 30 is fixed.

An aperture 62 is further formed on the holding element 54 in front of the window 30.

The holding element 54 is in particular an injection-moulded part.

The holding element 54 comprises a first holding arm 64 and a second holding arm 66. The first holding arm 64 and the second holding arm 66 are of an elastic (resilient) design and are seated on a holding element body 68, on which the aperture 62 is formed and which holds the window 30.

The first holding arm 64 and the second holding arm 66 each have a through-recess 70a, 70b. The recesses 70a, 70b have an at least approximately cylindrical shape and are aligned with one another.

The holding body 50 has a spherical surface 72. It is clamped with this spherical surface 72 between the first holding arm 64 and the second holding arm 66. It engages partially into the recesses 70a, 70b.

The holding body 50 and the holding arms 64, 66 form a joint device 74, by means of which the light-emitting diode 48 is pivotable relative to the housing 12. In particular, there is a first pivotal axis 76 that lies transversely of, and in particular at least approximately at right angles to, the principal direction 36 of the radiation beam 26. Owing to optical faults of the corresponding light source, the first pivotal axis 76 does not necessarily lie exactly at right angles to the principal direction 36; it is precisely such faults that may be compensated by means of the solution according to the invention.

The joint device 74 moreover has a second pivotal axis 78 that lies transversely of, and in particular at least approximately at right angles to, the first pivotal axis 76 and transversely of, and in particular at least approximately at right angles to, the principal direction 36. The first pivotal axis 76 and the second pivotal axis 78 in this case need not necessarily be spatially fixed pivotal axes.

Because the light-emitting diode 48 serving as light source 24 is pivotable on the joint device 74, the radiation beam 26 may be aligned with its principal direction 36 towards the light receiver 28.

The joint device 74 is a rigid joint device, which comprises joint elements (the holding body 50 and the holding arms 64, 66) that are rigid bodies.

When the holding element 54 plus the holding body 50 is fitted into the housing 12, then the radiation beam 26 may be aligned through pivoting on the joint device 74.

It may be provided that the holding body 50 has opposite-lying recesses 80a, 80b (FIG. 3), onto which a positioning element 82 may be applied. The positioning element 82 is removable. It may be inserted during manufacture of the light barrier device 10 into the channel-shaped recesses 80a, 80b and by virtue of a corresponding exertion of force a pivoting about the first pivotal axis 76 and/or the second pivotal axis 78 may be effected in order to align the radiation beam 26.

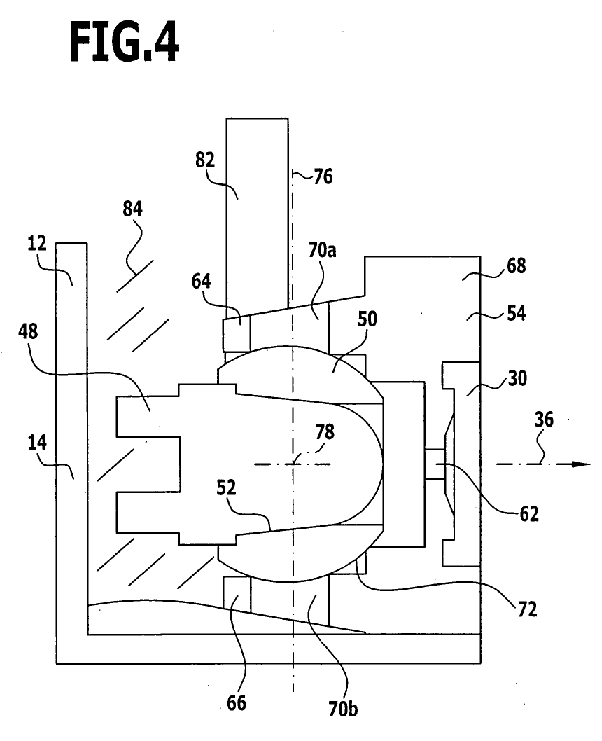

It is also possible for one or more positioning elements 82 to be permanently disposed on the holding body. For example, a positioning device 82 is inserted permanently into each recess 80a, 80b (cf. FIGS. 2 and 4). It is then possible for spaced positioning elements 82 to be connected by a bridge, which for example has ribbing as a contact area for an operator.

In a manufactured light barrier device 10 with a closed housing 12 the position of the light source 24 is fixed in a specific pivoted position, so that the alignment of the radiation beam 26 is fixed. For this purpose, the holding body 50 is fixed on the holding element 54.

In an embodiment, for this purpose the housing 12 at least in the region of the light-emitting diode 48 is filled and in particular sealed with a hardenable filling material 84 (FIG. 4). An epoxy resin for example is used as filling material 84.

To manufacture the light barrier device 10, the light receiver 28 and the light source 24 are positioned on the open housing 12. For example, for this purpose the holding body 50 with the light-emitting diode 48 is positioned on the holding element 54 and the holding element 54 is pushed in on the housing wall 60.

The light-emitting diode 48 is then aligned by pivoting the holding body 50 by means of the positioning element 82. The alignment is effected in such a way that the radiation beam 26 is incident centrally on the light receiver 28.

Then—after the alignment—the aligned position is fixed. For example, for this purpose the housing 12 is filled and closed.

In principle, it is also possible for the light receiver 28 to be positioned on the housing 12 by means of a corresponding articulated device in order to allow an alignment.

It is also possible for the joint device to be designed and/or for the manufacture of the light barrier device 10 to be effected in such a way that an alignment of the radiation beam 26 is possible also additionally after manufacture of the light barrier device and in particular during operation thereof.

It is in principle also possible that, instead of the joint device for positioning of the light source and/or of the light receiver taking the form of a rigid joint device with rigid joint elements (joint elements in the form of rigid bodies), a plastically deformable holding body is provided, wherein by virtue of a corresponding exertion of force a permanent deformation of the holding body is achieved, by means of which an alignment of the light source and/or of the light receiver is possible.

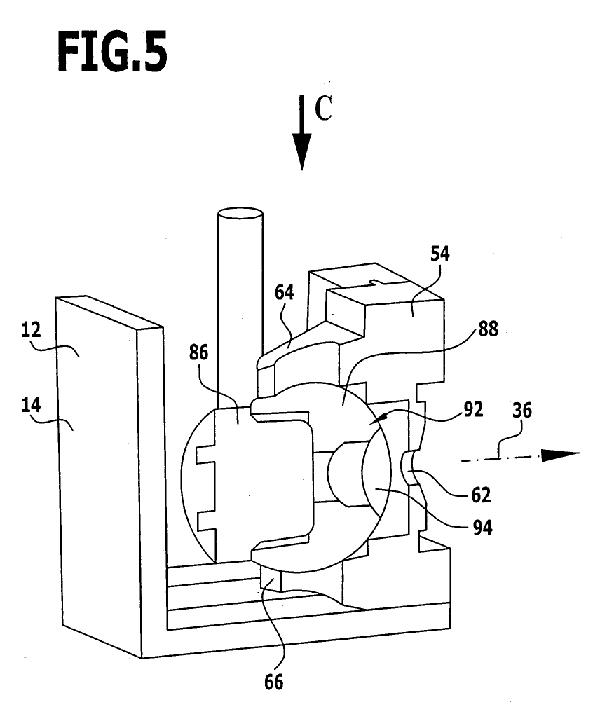

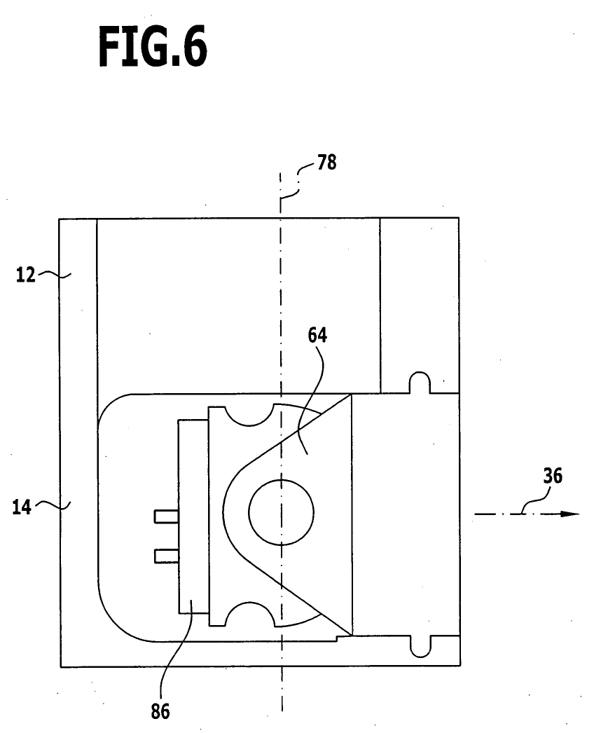

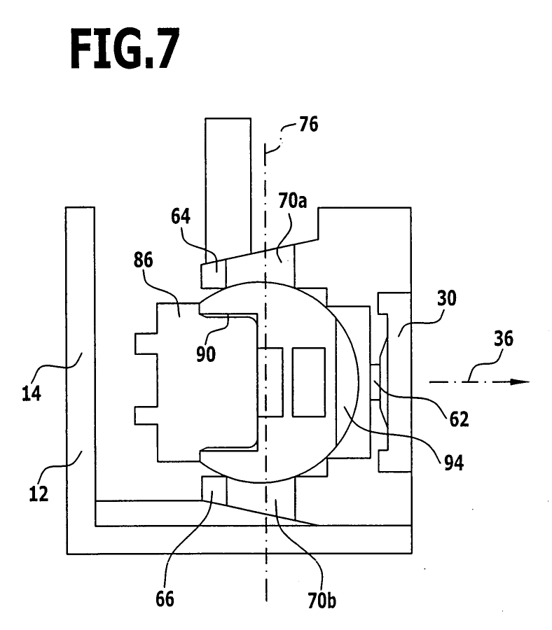

In a second embodiment, which is diagrammatically shown in FIGS. 5 to 7, a laser diode 86 is provided as a light source. The laser diode 86 is disposed in a holding body 88, which is held on a holding element. The holding element is fundamentally of an identical design to the holding element 54 described above. For this reason, the same reference characters are used. The holding element is further disposed on the housing 12 in a fundamentally identical manner to the holding element 54 described above. In this regard the same reference characters are likewise used.

The laser diode 86 is disposed in a recess 90 of the holding body. An optical device 92, which is associated with the laser diode 86, is likewise positioned on the holding body 88. A lens 94 of the optical device 92 is seated on the holding body 88 so as to face the aperture 62. In the holding body 88 an aperture of the optical device 92 is moreover seated between an output of the laser diode 86 and the lens 94.

By means of the holding body 88 the laser diode 86 plus its optical device 92 is pivotable as a whole relative to the housing 12 (during manufacture of the corresponding light barrier device). The radiation beam 26 may therefore be aligned with the light receiver 28.

By means of the holding body 88 in combination with the holding element 54 an articulated device is formed. The holding body 88 has a spherical surface in order to allow pivotability.

Otherwise, this embodiment operates in the manner described above. In particular, the laser diode 86 after alignment (by means of the holding body 88) is fixed relative to the housing 12.

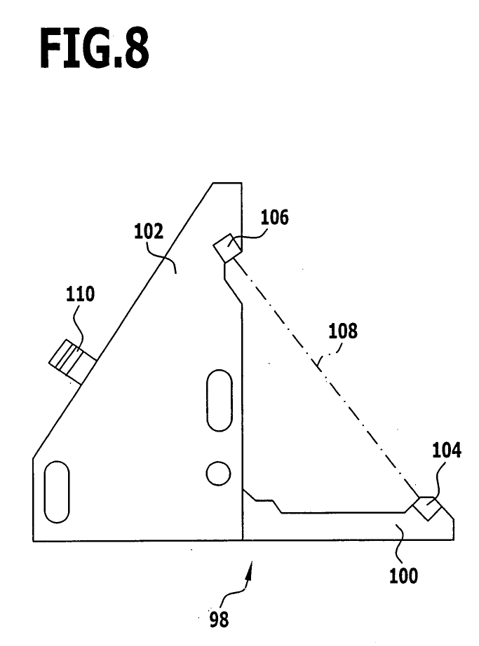

A further embodiment of a light barrier device according to the invention, which is shown in FIG. 8 and designated there by 98, is an angular light barrier having a first arm 100 and a second arm 102. The first arm 100 and the second arm 102 are directly connected to one another and oriented transversely of, and in particular at right angles to, one another.

Disposed on the first arm 100 is a light source 104. Disposed on the second arm 102 is a light receiver 106. An optical axis 108 lies transversely of, and in particular at an acute angle to, the first arm 100 and the second arm 102.

In the illustrated embodiment, the second arm 102 is of a triangular design. Disposed on it is a plug connection 110. It further accommodates an electrical circuit arrangement.

The light source 104 is positioned on the first arm 100 by means of a joint device corresponding to the articulated device 74. The light receiver 106 is positioned in a fixed manner on the second arm 102. Alternatively, it may also be mounted by means of a joint device.

As described in connection with the light barrier device 10, the light source 104 may at least during manufacture of the light barrier device 98 be aligned relative to the light receiver 106 in order to achieve an optimum alignment of the optical axis 108.

1. Light barrier device, comprising:
a housing;
a light source, by means of which a radiation beam is emittable; and
a light receiver;
wherein at least one of the light source and the light receiver is positioned on the housing with a joint device, by means of which at least one of the light source and the light receiver is movable relative to the housing for alignment of the optical axis.

2. Light barrier device according to claim 1, wherein at least one of the light source and the light receiver are alignable during at least one of manufacture of the light barrier device and operation of the light barrier device.

3. Light barrier device according to claim 1, wherein the joint device comprises rigid joint elements that are movable relative to one another.

4. Light barrier device according to claim 1, wherein the joint device has a first pivotal axis, which is oriented transversely of a principal direction of the radiation beam.

5. Light barrier device according to claim 4, wherein the joint device has a second pivotal axis, which is oriented transversely of the first pivotal axis and is oriented transversely of the principal direction of the radiation beam.

6. Light barrier device according to claim 1, wherein the joint device takes the form of a ball joint.

7. Light barrier device according to claim 1, wherein the joint device comprises a holding body, on which at least one of the light source and the light receiver is fixed.

8. Light barrier device according to claim 7, wherein the holding body at least during manufacture of the light barrier device is mounted pivotably on the housing.

9. Light barrier device according to claim 7, wherein the holding body at least in a bearing region has a spherical surface.

10. Light barrier device according to claim 7, wherein at least one of the light source and the light receiver is seated in a recess of the holding body.

11. Light barrier device according to claim 1, wherein at least one of a holding body for the light source and a holding body for the light receiver is seated on a holding element, which is disposed on the housing.

12. Light barrier device according to claim 11, wherein the holding element comprises at least a first holding arm and a second holding arm, between which the holding body is seated.

13. Light barrier device according to claim 12, wherein at least one of the first holding arm and the second holding arm are of a resilient design.

14. Light barrier device according to claim 12, wherein at least one of the first holding arm and the second holding arm has at least one recess, into which the holding body at least partially projects.

15. Light barrier device according to claim 11, wherein the holding element takes the form of a housing push-in element that is fixed on the housing.

16. Light barrier device according to claim 1, wherein a holding body of the joint device has one or more areas for application of a positioning element.

17. Light barrier device according to claim 1, wherein on a holding body of the joint device at least one positioning element is permanently disposed.

18. Light barrier device according to claim 1, wherein at least one of the light source and the light receiver is fixed in a specific pivoted position relative to the housing.

19. Light barrier device according to claim 1, wherein the joint device comprises a plastically deformable holding body, by virtue of the plastic deformation of which at least one of the light source and the light receiver are alignable.

20. Light barrier device according to claim 1, wherein the housing at least in the region of at least one of the light source and of the light receiver is filled with a filling material.

21. Light barrier device according to claim 1, wherein the light source comprises a light-emitting diode.

22. Light barrier device according to claim 1, wherein the light source comprises a laser diode.

23. Light barrier device according to claim 1, characterized by a first arm, on which the light source is disposed, and a second arm, on which the light receiver is disposed.

24. Light barrier device according to claim 23, wherein pivotal axes of the joint device are substantially parallel to a housing side of the first arm that faces the second arm.

25. Light barrier device according to claim 23, wherein the first arm and the second arm are substantially parallel to one another.

26. Light barrier device according to claim 23, wherein the first arm and the second arm are connected by a bridge.

27. Light barrier device according to claim 26, wherein the bridge lies normally between the first arm and the second arm.

28. Light barrier device according to claim 26, wherein on the bridge an electrical circuit arrangement is positioned.

29. Light barrier device according to claim 26, wherein on the bridge a plug connection element is disposed.

30. Light barrier device according to claim 23, wherein the first arm and the second arm are directly connected to one another.

31. Method of manufacturing a light barrier device, comprising the steps:
positioning of a light receiver on a housing;
positioning of a light source on the housing by means of a joint device; and
alignment of the light source relative to the light receiver by means of the joint device.

32. Method according to claim 31, wherein the light source is aligned at least by means of a first pivotal axis and a second pivotal axis lying transversely of the first pivotal axis.

33. Method according to claim 32, wherein the first pivotal axis and the second pivotal axis are each oriented transversely of a principal direction of a radiation beam of the light source.

34. Method according to claim 31, wherein the light source after the alignment is fixed so as to be locked against pivoting relative to the housing.

35. Method according to claim 34, wherein the light source is fixed in the housing by means of a filling material.

36. Method according to claim 31, wherein the articulated device comprises a holding body, which is disposed in a holding element.

37. Method according to claim 36, wherein the holding element takes the form of a housing push-in element that is fixed on the housing.

38. Method according to claim 31, wherein the light receiver is positioned on the housing by means of a joint device.
